(19) United States
(12) Patent Application Publication
(10) Pub. No.: US 2005/0128486 A1
(43) Pub. Date: Jun. 16, 2005

(54) Device and method for spectroscopically measuring a gas concentration by determining a single absorption line

(75) Inventors: Andreas Dietrich, Muenchen (DE); Peter Kasperson, Kjeller (NO); Karl Henrik Haugholt, Oslo (NO)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 10/996,037

(22) Filed: Nov. 24, 2004

Related U.S. Application Data
(63) Continuation of application No. PCT/EP03/05296, filed on May 20, 2003.

(30) Foreign Application Priority Data
Apr. 24, 2002 (DE) 102 23 239.3

(51) Int. Cl. G01N 21/61

(52) U.S. Cl. 356/436

(57) ABSTRACT

A device and a method for measuring a concentration of at least one component of a process gas by means of a laser is provided. The beam path of the laser penetrates a volume containing the process gas. One section of the beam path penetrates the process gas in a free manner while another section thereof is shielded from the process gas. Only the section of the beam path, which penetrates the process gas in a free manner, is designated as the section to be measured and is used for measuring the concentration by means of laser spectroscopy, exactly one absorption line being determined for said measurement.

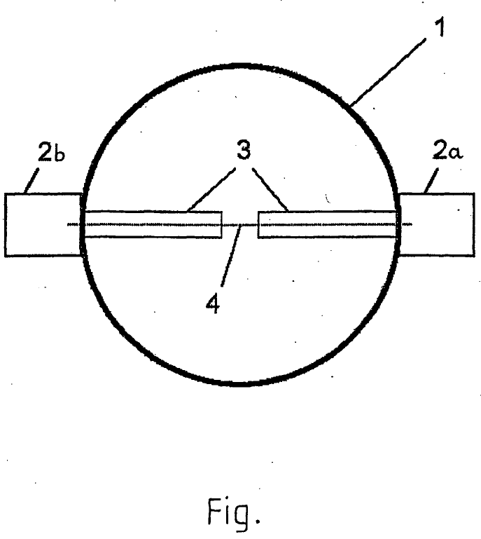

This application is a continuation of International Patent Application No. PCT/EP03/05296 filed on May 20, 2003, designating the United States of America, the entire disclosure of which is incorporated herein by reference. Priority is claimed based on German Patent Application No. DE 102 23 239.3 filed May 24, 2002.

### BACKGROUND AND SUMMARY OF THE INVENTION

The invention relates to a device and a method for measuring a concentration of at least one constituent of a process gas by means of a laser, the beam path of the laser traversing a volume containing the process gas.

Measuring methods and devices are known for determining the concentration of individual constituents of a gas mixture, which are determined by using a laser for laser-spectroscopic measurements.

However, when laser-spectroscopic methods are used for determining the concentration of constituents in dust-loaded process gases (gas mixtures), the known methods are limited by the occurring absorption and reflection of the laser irradiation by the dust particles. When the dust load is high and the measuring distances are fairly large, for example, over a fairly large tube cross-section, the intensity of the laser irradiation will considerably decrease over the measuring distance such that no usable signal arrives at the detector. The known methods are therefore not suitable for the described applications.

The above-described application case occurs comparatively frequently in the metal working field or in the power generating field and in power station engineering, because (process) gases contaminated by dust occur there in large quantities, whose composition is of considerable interest to the plant operator.

It is therefore an object of the present invention to provide an improved method and an improved device for implementing laser-spectroscopic measurements of the concentration of the constituents of a process gas, in which case the suitability of the invention is also particularly important for large volumes of dust-loaded processes gases.

With respect to the device, this object is achieved in that the beam path partially extends freely through the process gas and partially extends in a manner shielded from the process gas, only the portion of the beam path which leads freely through the process gas being provided as the measuring distance for a spectroscopic measurement of precisely one absorption line. This has the advantage that a precision of the measurement is achieved which is significantly increased in comparison to a spectroscopic measurement which measures through an area (scanning method). According to the invention, a so-called single-line spectroscopy is used. A laser is therefore advantageously used whose wavelength is defined or can be defined to a certain selected value which is also precisely observed. For example, an infrared laser with a precisely defined wavelength is used for the determination of carbon monoxide. In contrast, scanning lasers, thus lasers which measure through a wavelength range according to a defined sequence (scanning) are not suitable for the high precision which is an object of the present invention. On the basis of the restriction to only one frequency, a continuous automatic calibration of the laser can be achieved without other aids. In comparison, scanning lasers require one or several reference gas cells in order to continuously calibrate the laser by means of these gases.

The shield of the beam path is preferably constructed as a hollow body. Particularly preferably, devices for feeding a flush gas are provided in the area of the shield, which flush gas is used for displacing the process gas from the shield, particularly from the interior of the hollow body. As a result, a clean gas, whose composition is known, is advantageously present in the interior of the shield. This clean gas causes almost no weakening of the intensity of the laser beam and has a neutral behavior with respect to the concentration measurement or, because of the known composition, can be subsequently eliminated from the measurement. Nitrogen, for example, is very suitable for use as the flush gas. Inert gases can generally also be considered as suitable. The suitability of a gas as flush gas depends on, among other things, which constituent of the process gas it is whose concentration is to be determined.

In an advantageous further development of the invention, the shield has a tube-shaped construction. Particularly advantageously, the shield is constructed as a water-cooled lance. As a result of this construction, it is permitted that the device according to the invention can be used without any problem for measuring concentrations also in process gases having a very high temperature.

In an advantageous further development of the invention, the shield has a heat-resistant and/or acidproof material. The shield preferably has a ceramic material. These materials also permit the problem-free use of the device according to the invention under difficult conditions, for example, in the presence of acidic constituents in the process gas.

According to a further development of the invention, the shield is mounted at the beginning of the beam path in the case of the laser as well as in front of a detector onto which the laser irradiation impinges, whereby the measuring distance is bounded from both sides by the shield. This further development has, among others, the advantage that possibly existing marginal effects (effects in the marginal area of a gas volume) are extracted from the measurement. Interfering marginal effects may occur, for example, in a flowing process gas.

With respect to the method, the above-mentioned object is achieved in that the beam path extends partially freely through the process gas and extends partially in a manner shielded from the process gas, only the part of the beam path which extends freely through the process gas being called the measuring distance and being used for a spectroscopic measurement of the concentration by means of the laser, during which precisely one absorption line is determined. The thus created method permits a reliable measuring with a high precision also over larger measuring distances and in dust-loaded or otherwise contaminated process gases or process gases generally mixed with particles. In this case, the process gases can have a high temperature without leading to problems, because the spectral bands of the water vapor to be expected at higher temperature exercise no interfering influence on the measuring of a single absorption line (single-line spectroscopy) according to the invention.

The shield is advantageously flushed with a flush gas. Particularly advantageously, nitrogen is used as the flush gas. As a result, a clean gas, whose composition is known, is advantageously present in the interior of the shield, by which clean gas the laser beam experiences almost no attenuation of its intensity. This gas has a neutral behavior with respect to the measurement of the concentration; that is, it makes no contribution unless the concentration of a nitrogen compound is to be measured. In general terms, the suitability of a gas as flush gas depends on which constituent of the process gas it is whose concentration is to be determined. As a rule, a flush gas is preferably selected which, with respect to the spectroscopy, clearly differs from the gas whose concentration is to be determined.

Advantageously, inert gases can also be used as flush gases. Inert gases have the special advantage that a chemical reaction between the flush gas and the process gas can be excluded.

According to another advantageous further development of the method, ambient air is taken in by suction and is used as flush gas. This further development mainly offers the advantage of low process costs. However, the presence of ambient air is not desirable in all applications. For example, when determining the CO-concentration in a waste gas, ambient air as the flush gas would interfere with the measurement.

Likewise, for example, for measurements of the oxygen concentration in a process gas, nitrogen should be preferred as the flush gas.

The invention also has the advantage that, for measuring the concentration, a low-power laser can be used because the measuring distance is shortened by the shield according to the invention in comparison to a measurement without a shield. Furthermore, the use of a low-power laser advantageously reduces the risk of undesired changes in the process gas which could be triggered by the energy of the laser irradiation in the process gas.

The invention as well as additional details of the invention will be explained in detail in the following by means of an embodiment illustrated in the drawing.

Other objects, advantages and novel features of the present invention will become apparent from the following detailed description of the invention when considered in conjunction with the accompanying drawings.

### BRIEF DESCRIPTION OF THE DRAWINGS

The single drawing FIGURE is a cross-sectional schematic view of a volume containing process gas provided with a device for measuring concentration of the process gas constructed according to preferred embodiments of the invention.

### DETAILED DESCRIPTION OF THE DRAWINGS

The single drawing FIGURE is a detailed view of a volume 1 which is bounded in a tube-shaped manner, contains the process gas and, on one side, has a laser 2a and, on the opposite side, a detector 2b which records the laser irradiation traversing the volume 1 and impinging on the detector 2b. The beam path of the laser 2a is partly surrounded by the shield 3 which bounds the measuring distance 4 on both sides—in the direction of the laser 2a as well as in the direction of the detector 2b. Advantageously, devices for feeding a flush gas, such as nitrogen, are provided on the shield 3. These devices are not shown in the FIGURE.

The volume 1 is filled, for example, with a hot process gas (such as the waste gas of a steel mill furnace) which has a temperature of 800° C. or more and whose content of carbon monoxide is to be determined. For this purpose, a shield 3 is used which has two water-cooled ceramic tubes 3. Gaseous nitrogen is used as the flush gas, which displaces the process gas from the interior of the ceramic tubes 3, which are cooled, for example, by tube coils (not shown) carrying cooling water.

Advantageously, as a function of the distance between the laser 2a and the detector 2b, a shield 3 according to the invention has such dimensions that the measuring distance 4, for example, has a length of between 10 cm and 30 cm. A measuring distance 4 of approximately 20 cm is particularly advantageous.

The used laser is, for example, a variable laser which, according to the invention, is operated at a single frequency selected before the measurements. A variable laser has the advantage that, from its possible frequency range, that frequency (respective wavelength) can be selected which is well absorbed by the gas constituent to be determined. In this case, the weakening of the selected absorption line is a measurement for the concentration of the gas constituent in the process gas that is to be determined.

However, a single-mode laser can also be used which has a frequency matching the gas constituent to be determined.

The laser measurements can particularly advantageously be carried out as continuous measurements. However, in other embodiments of the invention, discontinuous measuring methods can also be successfully used.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Device for measuring a concentration of at least one constituent of a process gas, comprising a laser disposed so that a beam path of the laser traverses a volume containing the process gas,
wherein the beam path extends partially freely through the process gas and extends partially in a manner shielded from the process gas by a shield, and
wherein only a part of the beam path which extends freely through the process gas is provided as the measuring distance for a spectroscopic measurement of precisely one absorption line.

2. Device according to claim 1, wherein the shield of the beam path is constructed as a hollow body.

3. Device according to claim 2, wherein, in the area of the shield, devices are provided for feeding a flush gas which is used for displacing the process gas from the hollow body of the shield.

4. Device according to claim 1, wherein the shield has a tube-shaped construction.

5. Device according to claim 2, wherein the shield has a tube-shaped construction.

6. Device according to claim 3, wherein the shield has a tube-shaped construction.

7. Device according to claim 1, wherein the shield is constructed as a water-cooled lance.

8. Device according to claim 2, wherein the shield is constructed as a water-cooled lance.

9. Device according to claim 3, wherein the shield is constructed as a water-cooled lance.

10. Device according to claim 4, wherein the shield is constructed as a water-cooled lance.

11. Device according to claim 1, wherein the shield includes a heat-resistant and/or acidproof material.

12. Device according to claim 4, wherein the shield includes a heat-resistant and/or acidproof material.

13. Device according to claim 1, wherein the shield includes a ceramic material.

14. Device according to claim 1, wherein the shield is mounted at a beginning of the beam path in the case of the laser as well as in front of a detector on which the laser beam impinges, whereby the measuring distance is bounded from both sides by the shield.

15. Device according to claim 3, wherein the shield is mounted at a beginning of the beam path in the case of the laser as well as in front of a detector on which the laser beam impinges, whereby the measuring distance is bounded from both sides by the shield.

16. Device according to claim 4, wherein the shield is mounted at a beginning of the beam path in the case of the laser as well as in front of a detector on which the laser beam impinges, whereby the measuring distance is bounded from both sides by the shield.

17. Method of measuring a concentration of at least one constituent of a process gas by means of a laser, the beam path of the laser traversing a volume containing the process gas,
wherein the beam path partially extends freely through the process gas and partially extends in a manner shielded from the process gas by a shield, only the part of the beam path which extends freely through the process gas being called the measuring distance and being used for a spectroscopic measuring of the concentration by means of the laser, during which precisely one adsorption line is determined.

18. Method according to claim 17, wherein the shield is flushed by means of a flush gas.

19. Method according to claim 18, wherein nitrogen is used as the flush gas.

20. Method according to claim 17, wherein the shield of the beam path is constructed as a hollow body.

21. Method according to claim 20, wherein, in the area of the shield, devices are provided for feeding a flush gas which is used for displacing the process gas from the hollow body of the shield.

22. Method according to claim 20, wherein the shield is constructed as a water-cooled lance.

23. Method according to claim 20, wherein the shield is mounted at a beginning of the beam path in the case of the laser as well as in front of a detector on which the laser beam impinges, whereby the measuring distance is bounded from both sides by the shield.
